(19) United States
(12) Patent Application Publication
(10) Pub. No.: US 2012/0268266 A1
(43) Pub. Date: Oct. 25, 2012

(54) Warning Light System for Emergency Vehicles

(76) Inventors: John E. McLoughlin, Hauppage, NY (US); Neocles G. Athanasiades, Nesconset, NY (US); Kiam Meng Toh, Hauppage, NY (US)

(21) Appl. No.: 13/092,934

(22) Filed: Apr. 23, 2011

(51) Int. Cl. B60Q 1/52

(52) U.S. Cl. 340/471

(57) ABSTRACT

A vehicle-mounted warning light system comprises a housing containing a central light surrounded by several sets of outer lights. A controller is programmed to light the central first, and then each set of outer lights in sequence, while at the same time increasing the intensity of the lights, so that the system appears to an observer to be a single light that is getting bigger and brighter. This creates the illusion that the vehicle is travelling toward the observer faster than it actually is, thus prompting the observer to quickly yield right-of-way.

### BACKGROUND

1. Field of the Invention

This invention relates to the field of lighting systems. More particularly, the invention relates to a warning light system for emergency vehicles.

In a further and more specific aspect, the invention concerns a warning light system for creating the illusion that an emergency vehicle is travelling at a speed higher than its actual velocity.

2. Description of the Prior Art

Emergency vehicles such as fire trucks, ambulances, and police cars are typically fitted with warning light systems for alerting other motorists that they must yield the right-of-way. These systems may comprise steadily burning lights, flashing lights, rotating lights, LEDs, or strobe lights. They are available in various forms such as single beacons and elongated light bars, and can be integral with or secured to the rooftop, grille, or other location on the exterior of the vehicle. Regardless of the type of lighting system used, however, there are always drivers who fail to move quickly out of the way because they underestimate the speed at which the emergency vehicle is travelling. Under the best of circumstances, this will slow down the emergency vehicle; under the worst, it can cause a serious traffic accident.

Accordingly, it is an object of the present invention to provide a warning light system for emergency vehicles that, when activated, conveys a greater sense of urgency to surrounding motorists, pedestrians, and onlookers, prompting them to yield immediate right of way.

### SUMMARY OF THE INVENTION

The present invention achieves its objectives by taking advantage of the way the human eye and brain perceive motion. In general, objects appear to get larger and brighter as they approach an observer. An object that is travelling quickly appears to increase in size and brightness at a faster rate than an object that it is travelling slowly. By the same logic, if an object appears to be getting larger and brighter, the observer's brain perceives the object as getting closer even if it is actually stationary, or if the object is approaching, the observer's brain perceives it as travelling faster than it really is. Accordingly, the lighting system of the present invention comprises at least one light source and control means for varying the apparent size and brightness of the light source such that the light source appears to be travelling toward or away from an observer at a rate faster than the light source is actually travelling.

In a further and more specific embodiment of the invention, the lighting system comprises a plurality of lights, including at least one central light and at least one set of outer lights adjacent to the central light. The control means comprises a controller programmed to initially illuminate only the central light, and then to illuminate the outer lights so that the apparent size and brightness of the light source increase over time, giving the observer the impression that the light source is approaching more quickly than it actually is.

In one embodiment of the invention, the central and outer lights are collinear so they may be mounted on the vehicle in the form of a light bar. In another embodiment, the outer lights are arranged in concentric circles around the central light.

### BRIEF DESCRIPTION OF THE DRAWINGS

The foregoing and more specific objects and advantages of the instant invention will become readily apparent to those skilled in the art from the following detailed description of the preferred embodiments thereof taken in conjunction with the drawings in which:

FIGS. 1A-E are schematic drawings of a lighting system according to a first embodiment of the invention, wherein the lights are arranged in a straight line;

FIGS. 2A-E are schematic drawings of a lighting system according to a second embodiment of the invention, wherein the lights are arranged in concentric rings;

FIGS. 3A-D are graphs showing how the brightness of each set of lights within in a system varies over time and

FIG. 3E is a graph showing how the brightness of the entire system varies over time.

### DETAILED DESCRIPTION OF THE PREFERRED EMBODIMENT

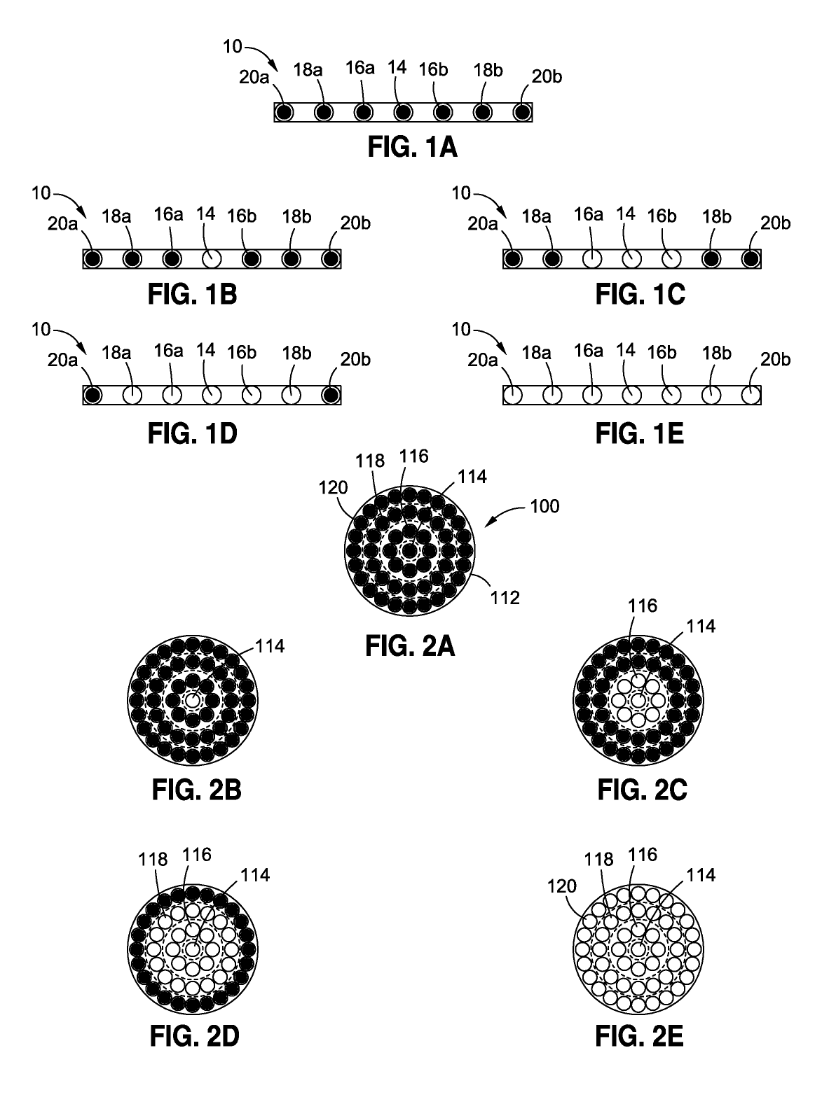

Turning now to the drawings in which like reference characters refer to corresponding elements throughout both views, attention is first directed to FIG. 1A, which shows a lighting system according to the a first embodiment of the invention, indicated in its entirety by the numeral 10. The lighting system 10 comprises a rectangular housing 12 containing a central light 14, a first pair of lights 16a,b arranged on opposite sides of the central light 14, a second pair of lights 18a,b arranged on opposite sides of the first pair of lights 16a, b, and a third pair of lights 20a,b arranged on opposite sides of the second pair of lights 18a,b. Although or illustrative purposes, the lights 14-20, which may be incandescent or LED, flashing or solid, white or colored, are shown to be spaced apart; they should be close enough together so that when all the lights are lit, they will appear to the viewer to be a single elongated light, rather than a number of individual lights.

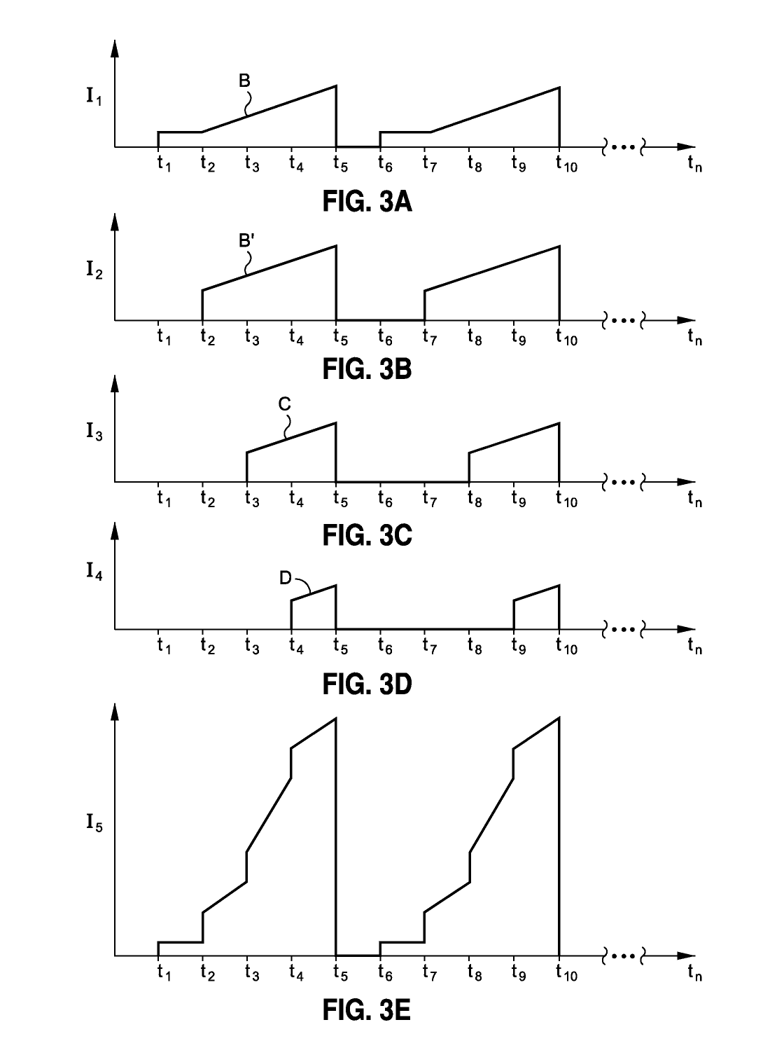

Initially, all of the lights 14-20 are turned off, as indicated by the dark shading in FIG. 1A, but at time t₁ the central light 14 turns on, as shown in FIG. 1B. The central light 14 is initially dim and may be constant, as shown by segment A in FIG. 3A, but at time t₂, its brightness I₁ begins to increase, as shown by segment B. Simultaneously, the first pair of lights 16a, b, turns on, as shown in FIG. 1C, and also begins to gradually increase in brightness I₂, as shown by segment B′ in FIG. 3B. At time t₃, the second pair of lights 18a, b, turns on, as shown in FIG. 1D, and increases in brightness I₃, as shown by segment C in FIG. 3C. At time t₄, the third pair of lights 20a,b turns on, as shown in FIG. 1E, and increases in brightness I₄, as shown by segment D in FIG. 3D. Finally, at time t₅, all the lights are turned off, and remain off until time t₆, when the whole process repeats itself.

FIG. 3E shows the total brightness I₅ of the light system 10 increasing over time. From time t₁ to time t₂, the total brightness I₅ is equal to the brightness I₁ of central light 14. From time t₂ to time t₃, the total brightness I₅ is equal to the brightness I₁ of the central light 14 plus the brightness I₂ of the first light pair 14a, b. From time t₃ to time t₄, the total brightness I₅ is equal to the brightness I₁ of the central plus the brightness I₂ of the first light pair 14a,b and the brightness I₃ of the second light pair 16a, b. From time t₄ to time t₅, the total brightness I₅ sum of the brightness I₁+I₂+I₃+I₄ of all of the lights individually.

To a an observer viewing from a distance, this does not appear as a number of lights being lit in sequence, but as a single light that is getting bigger and brighter over time, which creates the illusion that the lighting system (and therefore the vehicle on which it is mounted) is travelling towards the observer at a speed faster than it actually is. Conversely, the sequence could be reversed, with all the lights initially lit at full intensity and progressively being turned off toward the center while the brightness is also being reduced, to create the perception of faster movement away from the observer.

FIGS. 2A-E show a lighting system 110 according to a second embodiment of the invention, wherein the lights are arranged in a circular configuration. In this embodiment, the system comprises a circular housing 112 containing a central light 114, a first light ring 116 which surrounds the central light114, a second light ring 118 which surrounds the first ring of lights 116, and a third light ring 20 which surrounds the second light ring 118.

As in the first embodiment, all the lights are originally turned off, as shown in FIG. 2A. At a predetermined time, the center light 114a turns on, as shown in FIG. 2B, followed by the first light ring116 as shown in FIG. 2C, and then the light ring118 as shown in FIG. 2D, followed by the third light ring120 as shown in FIG. 2E. Finally, the entire system of lights then turns off, returning to the state shown in FIG. 2A, where the sequence repeats itself. Each light ring may consist of either a plurality of individual lights arranged in a circle, or a single annular light.

The foregoing two embodiments are intended as examples only, and are not intended to limit the invention in terms of the shape of the lighting system, number or spacing of lights, or the rate of change of intensity of lumination. For example, the lights need not become brighter at a linear rate as shown in FIGS. 3A-E, but can be programmed to intensify or dim in any fashion that effectively gives the impression of rapid movement toward (or away from) the observer. This can easily be determined by experimentation.

Various other modifications and variations to the embodiment herein chosen for purposes of illustration will readily occur to those skilled in the art. To the extent that such variations and modifications do not depart from the spirit of the invention, they are intended to be included within the scope thereof which is assessed only by a fair interpretation of the following claims.

Having fully described and disclosed the instant invention and a preferred embodiment thereof in such clear and concise terms as to enable those skilled in the art to understand and practice the same, the invention claimed is:

1. A warning light system for an emergency vehicle, comprising:
at least one light source; and
control means for varying the apparent size and brightness of the at least one light source such that the light source appears to be travelling toward or away from an observer at a rate faster than the light source is actually travelling.

2. The warning system according to claim 1, wherein:
the at least one light source comprises a plurality of lights, including at least one central light and at least one set of outer lights adjacent to the central light; and
the control means comprises a controller programmed to initially illuminate only the central light, and then to illuminate the outer lights so that the apparent size and brightness of the light source appear to increase over time, so that the light source appears to be approaching the observer at a rate faster than the actual velocity of the vehicle.

3. The warning system according to claim 2, wherein the at least one set of outer lights comprises at least one pair of lights arranged on opposite sides of the central light.

4. The warning system according to claim 3, wherein:
the at least one pair of lights comprises at least two pairs of lights, including a first pair immediately adjacent to the central light and a second located outwardly of the first pair; and
the controller is programmed to initially light the central light, followed by the first pair of lights, followed by the second pair of lights.

5. The warning system according to claim 2, wherein the at least one set of outer lights comprises at least one ring of light concentrically surrounding the central light.

6. The warning system according to claim 5, wherein:
the at least one ring of light includes at least two concentric rings of light, including a first ring immediately surrounding the central light, and a second ring surrounding the first ring; and
the controller is programmed to initially light the central light, followed by the first ring, followed by the second ring.

7. The warning system according to claim 2, wherein each of the lights is an LED.

8. The warning system according to claim 2, wherein each of the lights is an incandescent light.

9. The warning system according to claim 2, wherein each of the lights is a flashing light.

10. A method of inducing vehicles, pedestrians, and onlookers to quickly yield right-of-way to an oncoming emergency vehicle, comprising the steps of:
providing the vehicle with a light source and control means for varying the apparent size and brightness of the light source; and
increasing the apparent size and brightness of the light source in such a way as to make the light source appear to be approaching the vehicles, pedestrians, and onlookers at a faster rate than the actual velocity of the vehicle.

11. The method of claim 10, wherein the light source comprises a plurality of lights, including at least one central light and at least one set of outer lights adjacent to the central light; and
the step of increasing the apparent size and brightness of the light source comprises:
illuminating the at least one central light; and
subsequently illuminating the at least one set of outer lights.

12. The method of claim 11, wherein the at least one set of outer lights comprises at least one pair of lights arranged on opposite sides of the central light.

13. The method of claim 12, the at least one pair of lights comprises at least two pairs of lights, including a first pair immediately adjacent to the central light and a second located outwardly of the first pair; and
the step of increasing the apparent size and brightness of the light source comprises:
illuminating the at least one central light;
subsequently illuminating the first pair of lights; and
subsequently illuminating the second pair of lights.

14. The method of claim 11, wherein the at least one set of outer lights comprises at least one ring of light concentrically surrounding the central light.

15. The method of claim 14, wherein the at least one ring of light includes at least two concentric rings of light, including a first ring immediately surrounding the central light, and a second ring surrounding the first ring; and
the step of increasing the apparent size and brightness of the light source comprises:
illuminating the at least one central light;
subsequently illuminating the first ring of light; and
subsequently illuminating the second ring of light.

16. The method of claim 12, wherein each of the lights is an LED.

17. The method of claim 12, wherein each of the lights is an incandescent light.

18. The method of claim 12, wherein each of the lights is a flashing light.
